(19) United States
(12) Patent Application Publication
(10) Pub. No.: US 2019/0022715 A1
(43) Pub. Date: Jan. 24, 2019

(54) CLEANING DEVICE FOR CLEANING OF PIPES

(71) Applicant: RYDMAN HUSBYTORP AB, BRO (SE)

(72) Inventor: SVEN RYDMAN, BRO (SE)

(73) Assignee: RYDMAN HUSBYTORP AB, BRO (SE)

(21) Appl. No.: 15/652,887

(22) Filed: Jul. 18, 2017

(51) Int. Cl. B08B 9/045; B08B 9/043

(52) U.S. Cl. CPC B08B 9/045; B08B 9/0436

(57) ABSTRACT

A cleaning device for cleaning pipes includes a body having a longitudinal axis and at least three folding arms each having a rear and forward ends. The rear end of each folding arm is pivotably connected to the body so as to pivot about a respective pivot axis. The forward end of each folding arm is arranged to be folded outwards in a direction away from the longitudinal axis of the body under the influence of a centrifugal force generated by rotation of the body about the longitudinal axis. A rotatable means comprising cutter devices arranged to rotate about an axis of rotation is arranged at the forward end of each folding arm. Each rotatable means is arranged to project beyond the forward end of the folding arm and to mill both in a direction parallel to, and in a direction perpendicular to, the longitudinal axis of the body.

### BACKGROUND

### Field

The present invention relates to a cleaning device for cleaning of pipes.

### Background Information

When pipes such as water pipes, sewage pipes, etc. age, problems often arise with time, e.g., deposits may accumulate at the bottom of the pipe, the pipe wall may break due to roots penetrating there through, etc.

One way of taking care of problems of the above kind is to remove the old pipe and to thereafter replace it with a new pipe. This can however be very costly and time consuming.

An alternative to the complete replacement of an old pipe with a new is to instead clean out deposits etc. from the old pipe in order to thereafter recondition the old pipe by inserting a new pipe inside the old. In this way, an even and impermeable inner pipe wall is obtained without having to remove the old pipe. Instead of inserting a new pipe in the old, one may after the cleaning out of the old pipe provide the old pipe with a lining, i.e. to build up a new inner wall in the pipe by coating the inner wall of the old pipe with a layer of material, also called “relining”. This can, e.g., be done by applying epoxy on the inside of pipes using a rotating brush.

Another possible way to line pipes is to first clean out possible deposits, roots, concrete, etc. from within the old pipe in order to thereafter install a at the insertion flexible casing pipe against the inside of the old pipe, where the casing pipe comprises a material which at first is soft at the insertion and which thereafter stiffens and forms a new stiff and hard pipe lining inside of and engaging the inner wall of the pipe. The casing pipe may for example be a flexible porous tubular body made of synthetic material soaked with epoxy or other plastic material, e.g. polyester felt impregnated with epoxy, where the epoxy or the other plastic material stiffens after installation inside the pipe, and usually cures under pressurization of the inside cavity of said initially flexible lining.

One way to line old pipes where the lining comprises a flexible casing pipe is to use a flexible casing pipe which is turned inside out before insertion in the old pipe. One end of the flexible casing pipe is then turned right again before insertion so that this one end with the outer wall of the casing pipe facing outwards may be placed against and be held against the inner wall of the old pipe. Then, the remaining part of the casing pipe is fed into the old pipe while at the same time being turned right gradually so that the outside of the casing pipe is gradually placed against the inner wall of the old pipe. In such a way is obtained a lining of the old pipe using a casing pipe which stiffens after the insertion, e.g. in the way which has been mentioned above, and creates a stiff and hard tubular lining on the inside of the old pipe.

By cleaning the inside of an old pipe followed by a relining operation, problems in old pipes are taken care of quicker than when the old pipes are completely replaced by new ones. When cleaning pipes, it is known to clean the inside of a pipe using a rotating tube cleaner. U.S. Pat. No. 1,926,231 A shows a tube cleaner with rotatable cutting wheels. U.S. Pat. No. 2,500,238 A shows a tube cleaner with rotatable cutting wheels.

The present invention relates to an improved cleaning device for cleaning of pipes which addresses shortcoming in existing solutions.

### SUMMARY

Embodiments of the invention address the problem of cleaning the inside of a pipe by providing a cleaning device for cleaning of pipes.

By that a cleaning device comprising a body and at least three thereto pivotably connected folding arms connected at their respective rear end to the body, where the forward end of the respective folding arm is arranged to be folded outwards in a direction away from the longitudinal axis of the body under the influence of centrifugal force generated by rotation of the body about said longitudinal axis, where further a respective rotatable means comprising cutter devices is arranged at the forward end of the respective folding arm, where the respective rotatable means is arranged to project beyond the forward end of the respective folding arm and is arranged to mill both in a direction parallel to and in a direction perpendicular to said longitudinal axis of said body, is obtained the advantage of that the respective rotatable means is arranged to mill away obstacles inside the pipe at the forward end of the respective folding arm during operation of the cleaning device. Thus, the forward movement of the cleaning device will not be blocked by that the forward ends of the folding arms come into contact with obstacles inside the pipe.

A further advantage is that the folding arms are folded forwards and towards the longitudinal axis of the body if the cleaning device is pulled out backwards out of the pipe, whereby the risk that the cleaning device gets caught inside the pipe is minimized.

According to one aspect of the invention, the axis of rotation of at least one rotatable means is further arranged tilted about the corresponding folding arm, at an acute angle in relation to the pivot axis of said folding arm. Thus is obtained the advantage that no external feed force has to be applied from the outside on the cleaning device for driving the cleaning device along the inside of a pipe to be cleaned as the rotatable means with tilted axes of rotation, when engaging the inner wall of the pipe during rotation of the body, are arranged to drive the cleaning device along the inside of the pipe to be cleaned while cleaning the inside thereof.

According to one aspect of the invention, the pivot axis of said at least one folding arm and the tilted axis of rotation of the rotatable means arranged thereon are arranged in parallel planes.

According to one aspect of the invention, the acute angle between the axis of rotation of said rotatable means and said pivot axis is between 5°-85°, more preferably between 15°-75°, even more preferably between 25°-65°, and most preferably between 30°-45°.

According to one aspect of the invention, the folding arms are arranged symmetrically about the longitudinal axis of the body.

According to one aspect of the invention, the respective rotatable means are toothed wheels, where the cutter devices are cutting teeth.

According to one aspect of the invention, the respective rotatable means are wheels, where the cutter devices are cutting members.

According to one aspect of the invention, the body comprises means for receiving a drive member with which drive member the body is arranged to be able to be rotated about the longitudinal axis of the body.

According to one aspect of the invention, the respective folding arm comprises a respective first stop surface which in the folded out position of the respective folding arm is arranged to abut against a respective corresponding stop surface on the body and thereby block further folding out of the respective folding arms.

According to one aspect of the invention, the respective folding arm comprises an adjusting screw, where the respective stop surface is arranged at the end of a respective adjusting screw arranged on the respective folding arm.

According to one aspect of the invention, at least one cutter is arranged on the in the cleaning direction arranged end of the body and is arranged to mill obstacles situated in the central portion of the pipe cavity.

These and other objects, features, and characteristics of the invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

The invention will be described closer with reference to the attached drawings, where:

FIG. 1 shows schematically a partly sectioned side view of a cleaning device for cleaning of pipes according to an example embodiment of the invention;

FIG. 2 shows schematically a side view of a cleaning device according to another example embodiment of the invention;

FIG. 3 shows schematically a front view of a cleaning device according to FIG. 1;

FIG. 4 shows a rear view of a cleaning device according to FIG. 2; and

FIGS. 5 and 6 show, schematically, example embodiments of rotatable means comprising cutter devices.

### DESCRIPTION OF EXEMPLARY EMBODIMENTS

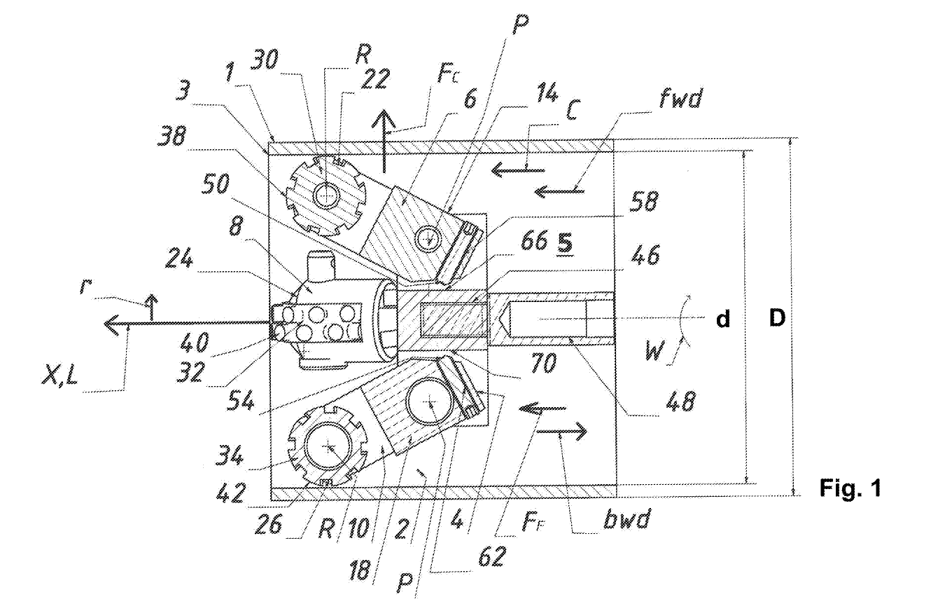

FIG. 1 shows schematically a partly sectioned side view of a cleaning device 2 for cleaning of pipes 1 according to an example embodiment of the invention, where the cleaning device 2 is shown in a folded out operating position inside a pipe 1.

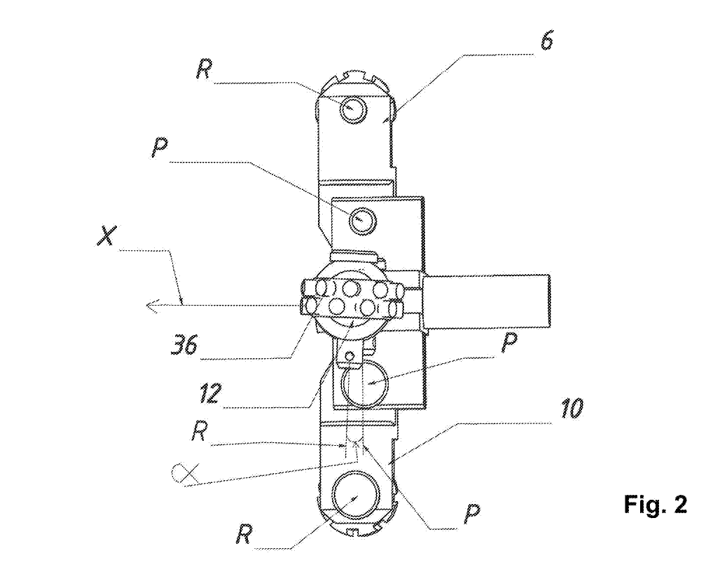

The invention relates to a cleaning device 2 for cleaning of pipes 1, i.e. for cleaning the inside of pipes 1, the cleaning device 2 comprising a body 4 and at least three folding arms 6, 8, 10, 12 pivotably connected thereto. In the figures, the invention is illustrated with four folding arms 6, 8, 10, 12, where the folding arm “12” is not shown in FIG. 1. For those reference signs below not shown in FIG. 1, see FIGS. 2 to 6.

The at least three folding arms 6, 8, 10, 12 are pivotably connected at their respective rear end 14, 16, 18, 20 to the body 4, where the forward end 22, 24, 26, 28 of the respective folding arm 6, 8, 10, 12 is arranged to be folded outwards in a direction away from the longitudinal axis X of the body 4 under the influence of centrifugal force Fc generated by rotation W of the body 4 about said longitudinal axis X, where further a respective rotatable means 30, 32, 34, 36 comprising cutter devices 38, 40, 42, 44 is arranged at the forward end 22, 24, 26, 28 of the respective folding arm 6, 8, 10, 12. As seen in the figure, the respective rotatable means 30, 32, 34, 36 is arranged to project beyond the forward end 22, 24, 26, 28 of the respective folding arm 6, 8, 10, 12, i.e. arranged to extend ahead of the forward end 22, 24, 26, 28 of the respective folding arm 6, 8, 10, 12, and is arranged to mill both in a direction parallel to and in a direction perpendicular to said longitudinal axis X of the body 4. In this way, the respective rotatable means 30, 32, 34, 36 is arranged to mill away obstacles at the inner wall 3 of the pipe 1, i.e. to mill in a direction perpendicular to said longitudinal axis X of the body 4, and also obstacles, such as e.g. concrete or roots that have penetrated into the pipe 1, situated inside the pipe 1 at the forward end of the respective folding arm 6, 8, 10, 12 and some distance away from the inner wall 3 of the pipe 1, i.e. to mill in a direction parallel to said longitudinal axis X of the body 4.

Preferably, the axis of rotation R of at least one rotatable means 30, 32, 34, 36 is further arranged tilted about the corresponding folding arm 6, 8, 10, 12, at an acute angle α in relation to the pivot axis P of said folding arm 6, 8, 10, 12, either in a direction corresponding to, or in a direction opposite to, the direction in which the body 4 is arranged to rotate W about said longitudinal axis X of the body 4, i.e. the axis of rotation R of said rotatable means 30, 32, 34, 36 is neither parallel to nor perpendicular to said pivot axis P (see FIG. 2 for reference signs “P”, “R” and “α”). The axis of rotation R of said respective rotatable means 30, 32, 34, 36 is thus arranged tilted at an acute angle α to said pivot axis P in a clockwise direction or in a counter-clockwise direction if the body 4 rotates W about said longitudinal axis X of the body 4 in a clockwise direction, and in a clockwise direction or in a counter-clockwise direction if the body 4 rotates W about said longitudinal axis X of the body 4 in a counter-clockwise direction. It is possible to arrange the axis of rotation R of all rotatable means 30, 32, 34, 36 tilted about the corresponding folding arm 6, 8, 10, 12, at an acute angle a in relation to the pivot axis P of said folding arm 6, 8, 10, 12.

The rotatable means 30, 32, 34, 36 with tilted axes of rotation are thus arranged to rotate backwards at the inner wall 3 of the pipe 1 when engaging the inner wall 3 of the pipe 1 during rotation of the body 4 about its longitudinal axis X, said rotatable means 30, 32, 34, 36 thus being arranged to drive the cleaning device 2 forward fwd along the inside 5 of the pipe 1 to be cleaned while also sliding against the inner wall 3 of the pipe 1, thus cleaning the inner wall 3 and the inside 5 of the pipe 1, i.e. milling both in a direction parallel to, i.e. in the forward fwd direction, and in a direction perpendicular to, i.e. in a radial r direction, said longitudinal axis X. If the axis of rotation R of each rotatable means 30, 32, 34, 36 is arranged tilted about the corresponding folding arm 6, 8, 10, 12, at an acute angle α in relation to the pivot axis P of said folding arm 6, 8, 10, 12, the drive force driving the cleaning device 2 forward fwd in the pipe 1 can be maximized.

In an example embodiment, the pivot axis P of said at least one folding arm 6, 8, 10, 12 and the tilted axis of rotation R of the rotatable means 30, 32, 34, 36 arranged thereon are arranged in parallel planes.

One or several foldable arms, 6, 8, 10, 12 may be replaced by foldable arms having an acute angle or a different acute angle α between the axis of rotation R of said rotatable means 30, 32, 34, 36 and the pivot axis P of the respective folding arm 6, 8, 10, 12 in order to adjust the driving force exerted by the rotatable means 30, 32, 34, 36 on the cleaning device 2. The acute angle α is more than 0° and less than 90°, preferably between 5°-85°, more preferably between 15°-75°, even more preferably between 25°-65°, and most preferably between 30°-45°. The larger the angle α, the faster the cleaning device moves in the pipe 1 at a specific rotational speed of the body 4 if not obstructed.

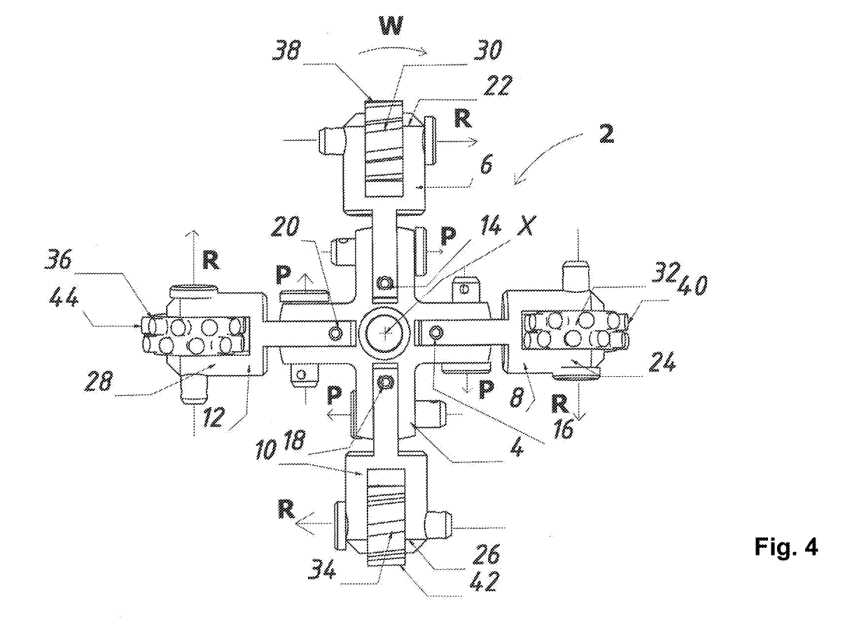

In FIG. 1, reference signs “P” and “R” have been inserted only for folding arms “6” and “10” but reference signs “P” and “R” also apply to folding arms “8” and “12” in corresponding ways (see FIGS. 2 and 4).

The folding arms 6, 8, 10, 12 are preferably arranged symmetrically about the longitudinal axis X of the body 4, this is in order to decrease the risk that the cleaning device 2 is tilted in the pipe 1 or is subjected to unbalance during operation. E.g., as shown in the Figure, one pair of folding arms 6, 10 can have non-tilted axes of rotation R for the rotatable means 30, 34, and another pair of folding arms 8, 12 can have tilted axes of rotation R for the rotatable means 32, 36.

The pivot axis P of the respective folding arm 6, 8, 10, 12 is preferably arranged in a plane perpendicular to the longitudinal axis X of the body 4.

If the cleaning device 2 encounters a solid obstacle in the pipe 1 blocking the movement of the cleaning device 2, e.g., without limitation, solidified concrete or a root, the cutter devices 38, 40, 42, 44 on the rotatable means 30, 32, 34, 36 will work on the obstacle until it is milled away, after which the cleaning device 2 will proceed with its movement along the inside of the pipe 1.

By that the respective rotatable means 30, 32, 34, 36 are arranged to mill away obstacles both in the direction parallel to and in a direction perpendicular to said longitudinal axis X of rotation of the body 4, the respective rotatable means 30, 32, 34, 36 are arranged to mill away obstacles that are situated at, close to and some distance away from the inner wall 3 of the pipe 1.

In operation, the body 4 rotates about its longitudinal axis X and is driven along the inside 5 of the pipe 1 in a cleaning direction C parallel to the center axis L of the pipe 1 and with the longitudinal axis X of the body 4 substantially aligned with the center axis L of the pipe 1 to be cleaned.

The respective rotatable means 30, 32, 34, 36 assist centering of the cleaning device 2 in the pipe 1 during operation.

The body 4 comprises means 46 for receiving a drive member 48 with which drive member 48 the body 4 is arranged to be able to be rotated W about the longitudinal axis X of the body 4.

The drive member 48 may e.g. be a wire or a drive output shaft, e.g., an drive output shaft of a water driven motor. Wire can be used if the pipe 1 to be cleaned is of limited length, e.g. about 30 meters. For longer pipes of up to several hundred meters in length it is preferred to use a water driven motor which motor is fed along the pipe together with the cleaning device 2. If wire is used as drive member 48, there exists specially twisted wire that can be subjected to press forces without the wire being bent in its longitudinal direction, as long as the length of wire used is in the tenth of meters range. The drive member 48 is in turn driven preferably by hydraulics or a motor. E.g., a hydraulic pump with variable pressure from 0 up to 180 bars can be used for the drive, which in turn for example can be driven with a combustion engine or an electrical plant. Thus, the drive member 48 is preferably further arranged to be able to take up press force in its axial direction along the longitudinal direction L of the pipe 1, whereby an additional feed force FF can be applied on the body 4 in the longitudinal direction L of the pipe 1 even if the cleaning device 2 is driven by at least one rotatable means 30, 32, 34, 36 the along the pipe in operation.

If the folding arms 6, 8, 10, 12 are folded out already at a rotational speed of about 1000 rotations per minute, the body 4 may in operation be rotated with for example a speed of about 2500-3000 rotations per minute in order to ensure the folding out of these.

In FIG. 1 is also shown the inner diameter d of the pipe 1, and the outer diameter D of the pipe 1.

In order for the cutter head 4 when it in operation rotates about its longitudinal axis X to fit within the inner diameter d of the pipe 1, the respective folding arm 6, 8, 10, 12 preferably comprises a respective first stop surface 50, 52, 54, 56, where the respective first stop surface 50, 52, 54, 56 preferably is arranged at the end of a respective adjusting screw 58, 60, 62, 64 when the respective folding arm 6, 8, 10, 12 comprises a respective adjusting screw 58, 60, 62, 64, which first stop surface 50, 52, 54, 56 in the folded out position of the respective folding arm 6, 8, 10, 12 is arranged to abut against a respective corresponding stop surface 66, 68, 70, 72 on the body 4 and thereby block further folding out of the respective folding arms 6, 8, 10, 12. In this way, the maximum diameter of the cleaning device 2 in the radial r direction can for example be set to and limited to some or a few mm less than the inner diameter d of the pipe 1.

The cleaning device 2 for cleaning of pipes 1 is preferably a cleaning device for cleaning of pipes with a substantially circular cross section, i.e. is preferably intended for pipes 1 with a substantially circular cross section of the pipe cavity, i.e. circular or somewhat oval. The cleaning device is not as suited for pipes with square or rectangular pipe cavity cross sections as the arms would oscillate in and out during rotation of the head thus causing impact forces on the inner walls of the pipe and unbalance in the cleaning device.

FIG. 2 shows schematically a side view of a cleaning device 2 according to another embodiment of the invention, and a frontal view of a folding arm 12. All folding arms 6, 8, 10, 12 pivotably connected to the body 4 preferably have the same weight distribution along their extension in order to minimize unbalance during rotation of the cleaning device 2, and this also facilitates manufacture of the cleaning device 2. In the figure is shown the pivot axis P for the folding arm 12, the axis of rotation R for the rotatable means 36 arranged on the folding arm 12 and the acute angle α between the pivot axis P for the folding arm 12 and the axis of rotation R for the rotatable means 36 arranged thereon. Folding arms 6, 8 and 10 have corresponding pivot axes P and axes of rotation R for the rotatable means 30, 32, 34 arranged thereon (see FIG. 1).

According to this embodiment, the respective folding arm 6, 8, 10, 12 can be folded out to an angle up to 90° but not more than 90° to the longitudinal axis X of the body 4. In the Figure is shown that the respective folding arm 6, 8, 10, 12 is folded out to an angle close to 90° to the longitudinal axis X of the body 4.

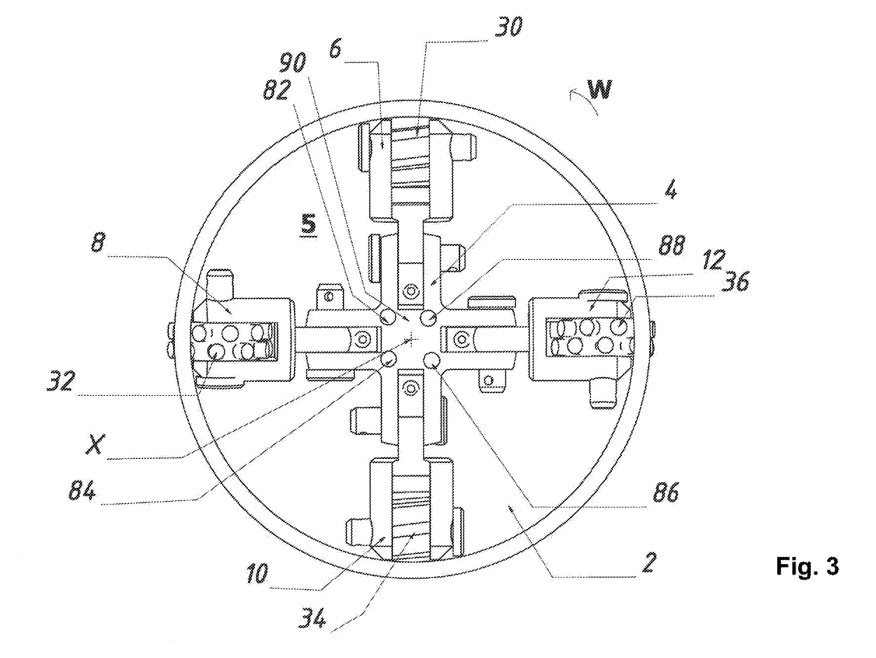

FIG. 3 shows schematically a front view of the cleaning device 2 according to FIG. 1. In the Figure is shown the body 4 and thereon pivotably arranged folding arms 6, 8, 10, 12 with thereon arranged rotatable means 30, 32, 34, 36 arranged for the in the figure indicated direction of rotation W for the cleaning device 2. In the figure it is assumed that the direction of rotation is clockwise as seen in the direction of the longitudinal axis X of the body 4, but the direction of rotation can also be counter-clockwise.

In the figure is shown an embodiment where the folding arms 6, 8, 10, 12 are pivotably arranged on the body 4 by that the body 4 and the folding arms 6, 8, 10, 12 have holes through which bolts 74, 76, 78, 80 are arranged in order to hold the folding arms 6, 8, 10, 12 to the body 4 in a pivotable way. If the bolts are locked with locking pins, the bolt heads are preferably arranged in the direction of rotation W of the body 4 in order to unload the locking pins. Washers may be arranged on the bolts between bolt heads and folding arms. By using bolts 74, 76, 78, 80 and locking pins, it is easy to replace worn rotatable means 30, 32, 34, 36.

Preferably, at least one cutter 82, 84, 86, 88 is arranged on the in the cleaning direction arranged end 90 of the body 4 and is arranged to mill obstacles situated in the central portion of the pipe cavity 5. This at least one cutter is arranged to mill away obstacles that the other cutter devices 38, 40, 42, 44 do not reach.

FIG. 4 shows a rear view of a cleaning device 2 according to FIG. 2. The Figure shows a cleaning device 2 for cleaning of pipes, i.e. for cleaning the inside of pipes, comprising a body 4 and four folding arms 6, 8, 10, 12 pivotably connected thereto. Also is shown the rear end 14, 16, 18, 20 and the forward end 22, 24, 26, 28 of the respective folding arm 6, 8, 10, 12, and the longitudinal axis X of the body 4. Also is shown a respective rotatable means 30, 32, 34, 36 comprising cutter devices 38, 40, 42, 44 arranged at the forward end 22, 24, 26, 28 of the respective folding arm 6, 8, 10, 12. As seen in the figure, the respective rotatable means 30, 32, 34, 36 is arranged to project beyond the forward end 22, 24, 26, 28 of the respective folding arm 6, 8, 10, 12, i.e. arranged to extend ahead of the forward end 22, 24, 26, 28 of the respective folding arm 6, 8, 10, 12. In this way, the respective rotatable means 30, 32, 34, 36 is arranged to mill away obstacles, such as, e.g., concrete or roots that have penetrated into the pipe, situated inside the pipe at the forward end of the respective folding arm 6, 8, 10, 12.

Preferably, the pivot axis P of at least one folding arm 6, 8, 10, 12 and the axis of rotation R of the rotatable means 30, 32, 34, 36 arranged thereon are arranged in parallel planes, where the axis of rotation R of said respective rotatable means 30, 32, 34, 36 is further arranged tilted at an acute angle α to said pivot axis P, i.e. the axis of rotation R of said rotatable means 30, 32, 34, 36 is neither parallel to nor perpendicular to said pivot axis P (for reference sign “α”, see FIG. 2).

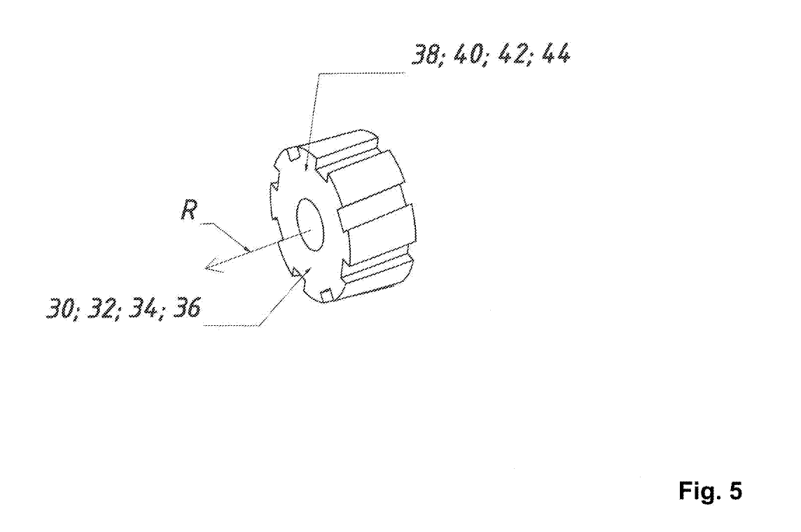

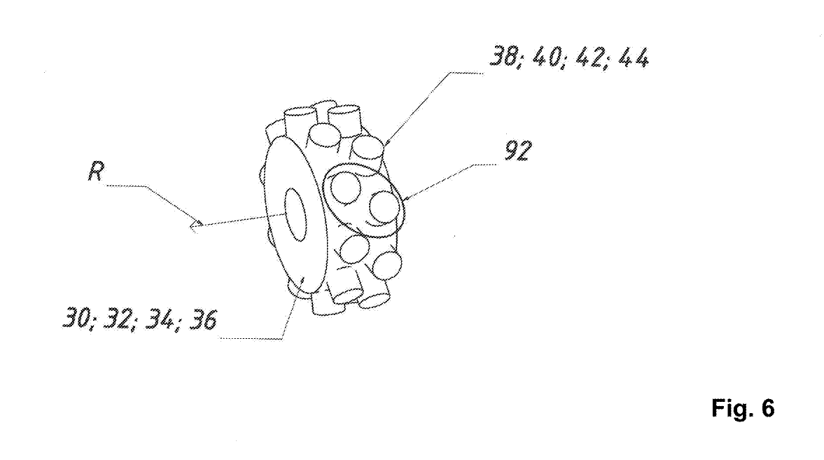

FIGS. 5 and 6 show schematically embodiments of rotatable means 30, 32, 34, 36 comprising cutter devices 38, 40, 42, 44.

FIG. 5 shows one aspect of the invention, according to which a rotatable means 30, 32, 34, 36 is a toothed wheel, and the cutter devices 38, 40, 42, 44 arranged thereon are cutting teeth. According to the embodiment shown in the Figure, the cutting teeth are arranged at an angle to the axis of rotation R of the respective wheel. The cutting teeth may optionally be arranged parallel to the axis of rotation R of the respective wheel. The cutting teeth preferably project radially outwards from the respective wheel.

FIG. 6 shows a further aspect of the invention, according to which a rotatable means 30, 32, 34, 36 is a wheel, where the cutter devices 38, 40, 42, 44 are cutting members arranged on the wheels. According to the embodiment shown in the Figure, the cutting members are arranged in groups 92 at an angle to the axis of rotation R of the wheel. The cutting members may optionally be arranged in groups parallel to the axis of rotation R of the respective wheel. The cutting members preferably project radially outwards from the respective wheel.

The wheels may be made of stainless steel.

The cutting members may be made of hardened steel, e.g. “2140”-grade hardened steel.

The cutting members may be fastened to holes in the wheels using a threaded joint.

The respective cutter devices 38, 40, 42, 44 comprise sharp cutter edges, i.e. with edge angle of 90° or less, which cutter edges are sharpened when the cutter devices 38, 40, 42, 44 slide against the inner wall 5 of the pipe 1 to be cleaned, i.e. the cutter devices 38, 40, 42, 44 are self-sharpening.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

1. A cleaning device for cleaning of pipes, the cleaning device comprising:
a body having a longitudinal axis; and
at least three folding arms each having a rear end and a forward end, each folding arm pivotably connected to the body at their respective rear end so as to pivot about a respective pivot axis,
wherein the forward end of each respective folding arm is arranged to be folded outwards in a direction away from the longitudinal axis of the body under the influence of a centrifugal force generated by rotation of the body about the longitudinal axis,
wherein a respective rotatable means comprising cutter devices arranged to rotate about an axis of rotation is arranged at the forward end of each respective folding arm, and
wherein each respective rotatable means is arranged to project beyond the forward end of the respective folding arm and is arranged to mill both in a direction parallel to, and in a direction perpendicular to, the longitudinal axis of the body.

2. The cleaning device of claim 1, wherein the axis of rotation of at least one rotatable means is further arranged tilted about the corresponding folding arm at an acute angle in relation to the pivot axis of the folding arm.

3. The cleaning device of claim 2, wherein the pivot axis of the at least one folding arm and the axis of rotation of the rotatable means arranged thereon are arranged in parallel planes.

4. The cleaning device of claim 2, wherein the acute angle between the axis of rotation of the rotatable means and the pivot axis is in the range of 5°-85°.

5. The cleaning device of claim 2, wherein the acute angle between the axis of rotation of the rotatable means and the pivot axis is in the range of 15°-75°.

6. The cleaning device of claim 2, wherein the acute angle between the axis of rotation of the rotatable means and the pivot axis is in the range of 25°-65°.

7. The cleaning device of claim 2, wherein the acute angle between the axis of rotation of the rotatable means and the pivot axis is in the range of 30°-45°.

8. The cleaning device of claim 1, wherein the folding arms are arranged symmetrically about the longitudinal axis of the body.

9. The cleaning device of claim 1, wherein the respective rotatable means are toothed wheels, and wherein the cutter devices are cutting teeth.

10. The cleaning device of claim 1, wherein the respective rotatable means are wheels, and wherein the cutter devices are cutting members.

11. The cleaning device of claim 1, wherein the body comprises means for receiving a drive member with which the body is arranged to be able to be rotated about the longitudinal axis of the body.

12. The cleaning device of claim 1, wherein the respective folding arm comprises a respective first stop surface which in the folded out position of the respective folding arm is arranged to abut against a respective corresponding stop surface on the body and thereby block further folding out of the respective folding arms.

13. The cleaning device of claim 12, wherein the respective folding arm comprises a respective adjusting screw, and wherein the respective first stop surface is arranged at the end of the respective adjusting screw arranged on the respective folding arm.

14. The cleaning device of claim 1, wherein at least one cutter is arranged on a cleaning direction end of the body and is arranged to mill obstacles situated in the central portion of the pipe cavity.
